(19) United States
(12) Patent Application Publication
(10) Pub. No.: US 2025/0018405 A1
(43) Pub. Date: Jan. 16, 2025

(54) GUIDING ARRANGEMENT, FLOTATION CELL AND FLOTATION METHOD

(71) Applicant: METSO FINLAND OY, ESPOO (FI)

(72) Inventors: Marly de Avila Carvalho, Helsinki (FI); Ian Michael Sherrell, Columbia, MD (US); Enkhzul Bayarmagnai, Pori (FI)

(73) Assignee: METSO FINLAND OY, ESPOO (FI)

(21) Appl. No.: 18/352,385

(22) Filed: Jul. 14, 2023

(51) Int. Cl. B03D 1/14; B03D 1/02

(52) U.S. Cl. CPC B03D 1/1456; B03D 1/02; B03D 2203/02

(57) ABSTRACT

A guiding arrangement configured to guide a slurry feed in a flotation tank of a flotation cell, a flotation cell and a flotation method. The guiding arrangement comprises at least one guiding plate arranged at the flotation cell. The at least one guiding plate is arranged obliquely in relation to the horizontal.

### BACKGROUND

The present disclosure relates to a guiding arrangement configured to guide slurry feed in a flotation tank. The present disclosure further relates to a flotation cell, comprising at least one guiding arrangement. The present disclosure still further relates to a flotation method.

There are still needs for increasing the overall recovery of flotation cells and intensifying recovering of coarse particles, i.e. particles bigger than 150 μm.

### BRIEF DESCRIPTION

Viewed from a first aspect, there can be provided a guiding arrangement configured to guide slurry feed in a flotation tank of a flotation cell, wherein the guiding arrangement comprises at least one guiding plate arranged at the flotation cell, wherein said at least one guiding plate is arranged obliquely in relation to the horizontal.

Thereby a guiding arrangement that moves the feed flow forward towards the overflow lip, breaks any latent downward velocity that the feed flow has after exiting the feeding device, increases the residence time of the particles, and helps direct upward flow of bubbles towards the overflow lip thereby increasing the overall recovery may be achieved.

Viewed from a second aspect, there can be provided a flotation cell for treating mineral ore particles suspended in slurry, the flotation cell comprising a flotation tank, a feeding device configured to feed slurry in the flotation tank, a gas supply for introducing flotation gas into slurry in the flotation tank, and the guiding arrangement according to the first aspect arranged in the flotation tank, which guiding arrangement is configured to direct slurry discharged from the feeding device toward an overflow lip of the flotation tank.

Thereby a flotation cell providing high recovery of coarse particles may be achieved.

Viewed from a third aspect, there can be provided a flotation method for treating particles suspended in slurry, wherein the slurry is separated into an overflow and an underflow in a flotation cell according to the second aspect.

Thereby a flotation method providing high recovery of mineral ore particles may be achieved.

The guiding arrangement, the flotation cell and the method are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

Various embodiments of the aspects may comprise at least one feature from the following paragraphs:

In one embodiment, the guiding arrangement comprises at least two guiding plates arranged at two horizontally different imaginary planes.

An advantage is that the guiding effect of the guiding arrangement may be strengthen.

In one embodiment, the guiding plates are arranged below a feeding device configured to feed slurry in the flotation tank so that an immediate contact between the feed and the guiding plates is ensured.

An advantage is that moving of the feed flow towards the overflow lip may be intensified.

In one embodiment, the guiding arrangement is configured to guide slurry feed within a froth layer in a flotation tank of a froth flotation cell.

An advantage is that moving of the feed flow towards a froth overflow lip may be intensified, any latent downward velocity that the feed flow has after exiting the feeding device may be broken, the residence time of the particles in the froth layer may be increased, and direct upward flow of bubbles within the froth towards the froth overflow lip may be helped, thereby the overall recovery of the froth flotation cell may be increased.

In one embodiment, the guiding plates are arranged in a surrounding form and below a feeding device configured to feed slurry in the flotation tank so that an immediate contact between the feed and the guiding plates is ensured.

An advantage is that the feed flow is effectively and comprehensively guided towards the froth overflow lip and latent downward velocity that the feed flow has after exiting the feeding device is slowed down, thus extending the residence time of the feed in the froth layer.

In one embodiment, the uppermost guiding plate of the at least two guiding plates is arranged to a position where it guides a part of the feed to a guiding plate beneath thereof. An advantage is that the guidance of the feed may be intensified.

In one embodiment, the overall shape of the guiding plate is roundish, such as ring-shaped, and it extends obliquely downwards from its inner edge to its outer edge.

An advantage is that the feed can be distributed 360° around the guiding arrangement.

In one embodiment, the guiding plates are arranged at an angle of 10° to 60° to the horizontal.

An advantage is that the feed can be guided and the downward velocity reduced effectively.

### Definitions

This summary of definitions is provided to introduce a selection of concepts in a simplified form that are further described below in the detailed description. This summary is not intended to identify key features or essential features of the claimed subject matter, nor is it intended to be used to limit the scope of the claimed subject matter.

Throughout this specification, “flotation” may refer to separation of a mixture by adhering a substance in said mixture at an interface. In flotation, separation of a mixture may be based on differences in the hydrophobicity of substances in said mixture. Herein, “separation” may refer to the extraction or removal of a substance from a mixture for use or rejection.

Further, “froth flotation” may refer to flotation, wherein froth is utilized for separation. Herein, “froth” may refer to a dispersion, comprising a greater portion by volume of flotation gas dispersed as bubbles in lesser portion by volume of a flotation liquid. Generally, froth may or may not be stabilized by solid particles.

In this disclosure a “froth layer” may refer to a layer comprising, or comprising substantially, or consisting essentially of, or consisting of froth.

Throughout this specification, slurry being “fed to a froth layer” may refer to feeding said slurry onto, and/or into, and/or immediately below, e.g., at most two times the froth depth, or at most the froth depth, or at most ½ of the froth depth, or at most ⅕ of the froth depth, or at most 1/10 of the froth depth below, the surface of said froth layer, and/or into the froth slurry interface. Additionally or alternatively, in embodiments, wherein a height of a froth overflow lip defines a height of an upper surface of a froth layer, slurry being fed to said froth layer may refer to feeding said slurry into a flotation tank at said froth collection launder lip height and/or at a position at most the froth depth, or at most ½ of the froth depth, or at most ⅕ of the froth depth, or at most 1/10 of the froth depth, or at most 1/50 of the froth depth below said launder lip height.

Further, “slurry” may refer to a dispersion, comprising solid particles suspended in a continuous phase of flotation liquid.

Herein, a “froth depth” may refer to a thickness of a froth layer in a flotation tank. A froth depth may be measurable as a vertical distance between a launder lip and a surface of a slurry in a flotation tank, when said flotation tank is in use.

In this disclosure froth slurry interface may refer to a layer on top of the slurry where gas hold-up percentage is between 10-50.

### BRIEF DESCRIPTION OF FIGURES

Some embodiments illustrating the present disclosure are described in more detail in the attached drawings, in which

FIG. 1 is a schematic view of a guiding arrangement, a froth flotation cell and a method in partial cross-section;

FIG. 2a is a schematic view of a guiding arrangement;

FIG. 2b is a schematic side view of the guiding arrangement shown in FIG. 2a;

FIG. 3 is a schematic view of a detail of a guiding arrangement in partial cross-section; and

FIG. 4 is a schematic view of another guiding arrangement.

In the figures, some embodiments are shown simplified for the sake of clarity. Similar parts are marked with the same reference numbers in the figures.

### DETAILED DESCRIPTION

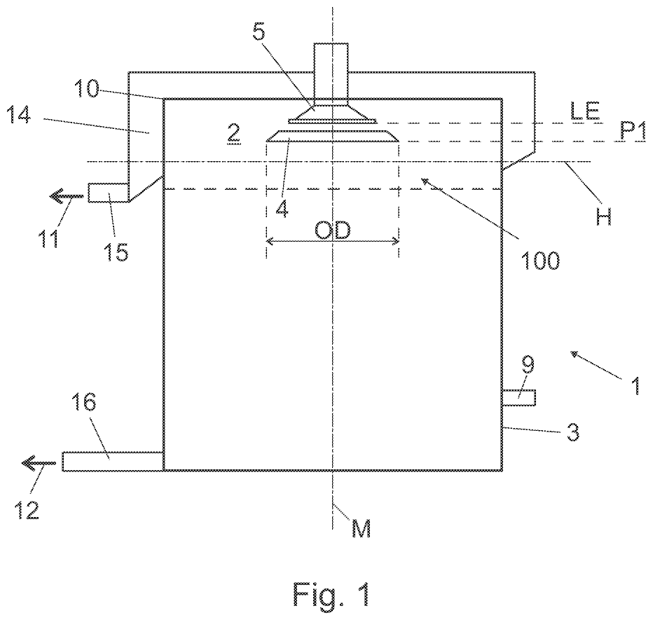

FIG. 1 is a schematic view of a guiding arrangement, a froth flotation cell and a method in partial cross-section.

In one embodiment, the froth flotation cell 1 is configured to treat coarse mineral ore particles suspended in slurry and separate slurry into an overflow 11 and underflow 12. The flotation cell 1 may be a mechanically agitated flotation cell or a column flotation unit.

The flotation cell 1 comprises a flotation tank 3 and a gas supply 9 for introducing flotation gas into slurry in the flotation tank 3 to form a froth layer 2 at the top of the flotation tank 3.

In one embodiment, the flotation tank 3 is circular. In another embodiment, the flotation tank 3 is polygonal, such as rectangular.

In one embodiment, the flotation cell 1 comprises a mixing device, such as rotor-stator type agitator, and the gas supply 9 is arranged in connection with the mixing device. Alternatively, the gas supply 9 may comprise gas inlets, such as nozzles or spargers, configured to introduce flotation gas into the flotation tank 3, as is the case in a column flotation cell.

In one embodiment, the flotation cell 1 is a froth flotation cell. The flotation tank 3 of the froth flotation cell comprises a froth collection launder 14 having a froth overflow lip 10 arranged in the upper part of the flotation tank 3. In one embodiment, the froth overflow lip 10 surrounds the perimeter of the flotation tank 3. During the use of the flotation cell 1, a froth layer 2 is formed at the top of the flotation tank 3. Froth, which contains flotation gas bubbles agglomerated with mineral ore particles, is discharged from the froth layer 2 over the froth overflow lip 10 into the froth collection launder 14, and out of the flotation cell 1 through an overflow outlet 15 as overflow 11.

The flotation tank 3 further comprises a tailings outlet 16 arranged at the bottom or side wall near the bottom of the flotation tank 3. Tailings or underflow 12 is discharged from the flotation tank 3 through the tailings outlet 16.

The flotation cell 1 comprises a feeding device 5. In one embodiment, the feeding device 5 is configured to feed slurry directly to the froth layer 2 formed at the top of the flotation tank 3. In other words, the feeding device 5 is configured to feed the slurry for interaction with froth layer 2 above the froth layer 2, and/or in the froth layer 2, and/or into froth slurry interface, and/or under the froth layer 2 in proximity thereof, e.g., at most two times the froth depth, or at most the froth depth, or at most ½ of the froth depth, or at most ⅕ of the froth depth, or at most 1/10 of the froth depth under said froth layer 2.

In one embodiment, the slurry fed by the feeding device 5 contains coarse mineral ore particles, i.e. particles having diameter greater than 150 μm.

A guiding arrangement 100 configured to guide slurry feed from the feeding device 5 within the froth layer 2 is arranged in the flotation tank 3. The guiding arrangement 100 shown in FIG. 1 comprises one guiding plate 4 that is arranged at horizontal imaginary plane P1.

In one embodiment, the guiding plate 4 lies in the froth layer 2 during operation of the froth flotation cell 1 and it is arranged obliquely, i.e. downward sloping, in relation to the horizontal H.

In one embodiment, the horizontal imaginary plane P1 is under the lower edge LE of the feeding device.

In one embodiment, such as shown in FIG. 1, the flotation tank 3 has a shape of circular cylinder and the feeding device 5 is arranged on the vertical middle axis M thereof. The guiding plate 4 is arranged in a surrounding form around the same middle axis M. It is to be noted that the guiding arrangement 100 and the guiding plate(s) thereof may be placed many alternative ways in the flotation tank. In one embodiment, at least one guiding plate is arranged off-center the vertical middle axis. In one embodiment, at least one guiding plate is arranged at or near the wall of the flotation tank. In one embodiment, the guiding arrangement 100 comprises at least one straight or rectangular guiding plate. In one embodiment, the guiding arrangement 100 comprises at least one curved or curvy-shaped guiding plate. In one embodiment, the guiding arrangement 100 comprises guiding plates having different shapes.

The guiding plate 4 directs the upward flow of flotation gas bubbles within the froth layer 2 towards the froth overflow lip 10, slow down the downward velocity that the slurry flow has after exiting the feeding device 5 and thus increase the residence time of the slurry in the froth layer 2.

The flotation cell 1 may be operated as follows. A froth layer 2 is formed at the top of the flotation tank 3 by introducing flotation gas into the slurry in the flotation tank 3. Slurry is fed from the feeding device 5, wherefrom it flows on the guiding plate 4 and along them toward the froth overflow lip 10.

Hydrophobic particles contained in the slurry feed adhere to the flotation gas bubbles in the froth layer 2. The bubble-particle agglomerates are removed from the flotation tank 3 over the froth overflow lip 10 to the froth collection launder 14. Hydrophilic particles pass through the froth layer 2 to the slurry below it and are discharged from the flotation tank 3 with underflow 12.

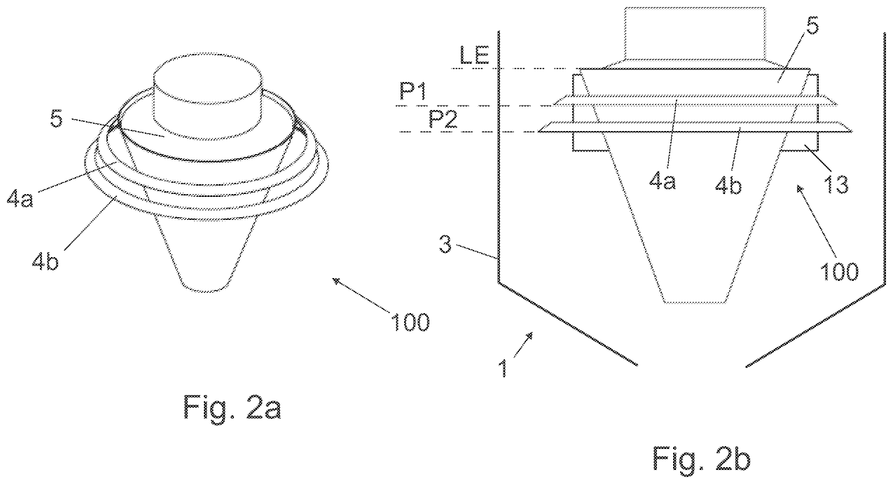

FIG. 2a is a schematic view of a guiding arrangement and FIG. 2b is a schematic side view of the guiding arrangement shown in FIG. 2a.

The guiding arrangement 100 shown in FIGS. 2a, 2b comprises two guiding plates 4 arranged at two horizontally different imaginary planes P1, P2. The guiding plates 4 lie in the froth layer 2 during operation of the froth flotation cell 1 and they are arranged obliquely, i.e. downward sloping, in relation to the horizontal H.

In one embodiment, the guiding plates 4 are arranged in a stepped manner so that slurry flows from the upper guiding plate 4a onto the lower guiding plate 4b.

In other embodiments the guiding arrangement 100 comprises three or more than three guiding plates 4.

In one embodiment, the horizontally different imaginary planes P1, P2 are under the lower edge LE of the feeding device.

In one embodiment, all the guiding plates 4 arranged in the guiding arrangement 100 have a same overall shape. In one embodiment, the overall shape of the guiding plates 4 is roundish, such as ring-shaped. For instance, each of the guiding plates 4 shown in FIG. 2 have a shape of strip that has been bent into form of a circular truncated cone surface.

The guiding plates 4 may be manufactured from metallic materials, such as steel, or composite materials, such as reinforced polymer composites.

In one embodiment, the guiding plates 4 are supported to the structure of the flotation tank 3 by at least one support 13.

In one embodiment, the guiding plates 4 are arranged in a surrounding form and below a feeding device 5 that feeds slurry in the flotation tank. The guiding arrangement is positioned so that the slurry meets the guiding plates 4 immediately after exiting the feeding device 5.

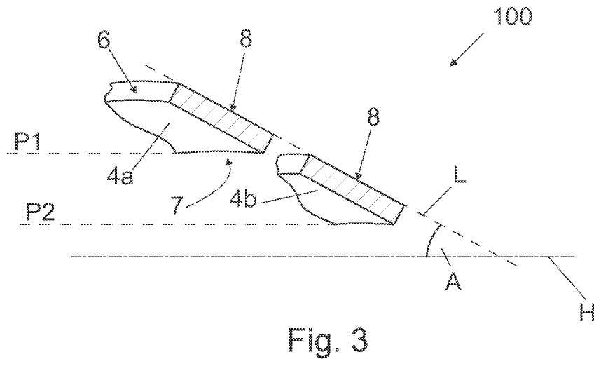

FIG. 3 is a schematic view of a detail of a guiding arrangement in partial cross-section. As already disclosed, the overall shape of the guiding plates 4 may be roundish, such as ring-shaped. In one embodiment, the uppermost guiding plate 4a in the guiding arrangement has a smaller outer diameter OD (shown in FIG. 1) as the lowermost guiding plate 4b of said guiding arrangement.

In one embodiment, the guiding plate 4 arranged in the roundish overall shape has an angular cross section. The embodiment shown in FIG. 3 comprises guiding plates 4 that have a quadrangular cross-section. The cross-section may be square, parallelogram, trapezoid, for instance. It is to be noted that all the guiding plates need not to have same cross-sectional shape (or size) in the guiding arrangement 100.

In one embodiment, the guiding plate 4 is arranged so that it extends obliquely downwards from its inner edge 6 to its outer edge 7. In one embodiment, the guiding plate 4 is arranged at an angle A of 10° to 60° to the horizontal. In one embodiment, such as shown in FIG. 3, all the guiding plates 4 have the same angle A to the horizontal. In another embodiment, the guiding arrangement 100 comprises guiding plates 4 arranged in different oblique angles.

In one embodiment, such as shown in FIG. 3, the upper surfaces 8 of the guiding plates are arranged at a same oblique line L. In one embodiment, adjacent guiding plates are arranged partly overlapping manner.

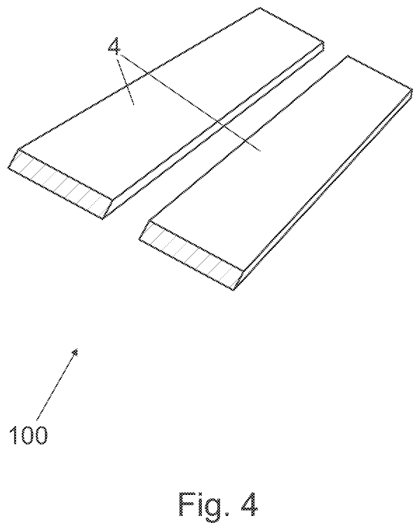

FIG. 4 is a schematic view of another guiding arrangement. In this guiding arrangement 100 the overall shape of the guiding plates 4 is rectangular. This kind of embodiment may be advantageous in flotation tanks having polygonal, such as quadrangular, shape. However, rectangular guiding plates can also be arranged in round or cylindrical flotation tanks. It is also to be noted, that roundish, such as ring-shaped, guiding plates can be arranged in polygonal, such as quadrangular, flotation tanks.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 flotation cell
2 froth layer
3 flotation tank
4 guiding plate
5 feeding device
6 inner edge
7 outer edge
8 upper surface
9 gas supply
10 overflow lip
11 overflow
12 underflow
13 support
14 collection launder
15 overflow outlet
16 tailings outlet
100 guiding arrangement
A angle
H horizontal
L oblique line
LE lower edge
M middle axis
P plane
OD outer diameter

1. A guiding arrangement configured to guide a slurry feed in a flotation tank of a flotation cell, wherein the guiding arrangement comprises:
at least one guiding plate arranged at the flotation cell, wherein
said at least one guiding plate is arranged obliquely in relation to horizontal.

2. The guiding arrangement as claimed in claim 1, comprising:
at least two guiding plates arranged at two horizontally different imaginary planes.

3. The guiding arrangement as claimed in claim 1, wherein all the guiding plates have a same overall shape.

4. The guiding arrangement as claimed in claim 1, wherein the overall shape of the guiding plates is roundish, such as ring-shaped.

5. The guiding arrangement as claimed in claim 1, wherein the guiding plate(s) is/are arranged in a surrounding form around a vertical middle axis of the flotation tank.

6. The guiding arrangement as claimed in claim 1, wherein the guiding plate(s) is/are arranged in a surrounding form and below a feeding device configured to feed slurry in the flotation tank.

7. The guiding arrangement as claimed in claim 6, wherein the flotation cell is a froth flotation cell, and wherein the feeding device is configured to feed slurry to a froth layer.

8. The guiding arrangement as claimed in claim 1, wherein the at least one guiding plate has a rectangular shape.

9. The guiding arrangement as claimed in claim 1, wherein the flotation cell is a froth flotation cell, and wherein the at least one guiding plate is arranged within a froth layer so that said at least one guiding plate lies in the froth layer during operation of the flotation cell.

10. The guiding arrangement as claimed in claim 2, wherein an uppermost guiding plate of the at least two guiding plates has smaller outer diameter as a lowermost guiding plate of said at least two guiding plates, and that said uppermost guiding plate is configured to guide at least a part of the feed to said lowermost guiding plate.

11. The guiding arrangement as claimed in claim 1, wherein the at least one guiding plate extends obliquely downwards from an inner edge to an outer edge.

12. The guiding arrangement as claimed in claim 1, wherein the at least one guiding plate is arranged at an angle of 10° to 60° to horizontal.

13. The guiding arrangement as claimed in claim 2, wherein the at least two guiding plates have a same angle to horizontal.

14. The guiding arrangement as claimed in claim 13, wherein the upper surfaces of the at least two guiding plates are arranged at a same oblique line.

15. A flotation cell for treating mineral ore particles suspended in slurry, the flotation cell comprising:
a flotation tank;
a feeding device configured to feed the slurry in the flotation tank;
a gas supply for introducing flotation gas into the slurry in the flotation tank; and
a guiding arrangement configured to guide the slurry feed in the flotation tank, wherein the guiding arrangement comprises:
at least one guiding plate arranged at the flotation cell, wherein
said at least one guiding plate is arranged obliquely in relation to the horizontal, and wherein
the guiding arrangement is configured to direct slurry discharged from the feeding device toward an overflow lip of the flotation tank.

16. A flotation method for treating particles suspended in slurry, wherein the slurry is separated into an overflow and an underflow in a flotation cell, the flotation cell comprising
a flotation tank,
a feeding device configured to feed the slurry in the flotation tank,
a gas supply for introducing flotation gas into the slurry in the flotation tank, and
a guiding arrangement configured to guide the slurry feed in the flotation tank, wherein the guiding arrangement comprises:
at least one guiding plate arranged at the flotation cell, wherein
said at least one guiding plate is arranged obliquely in relation to the horizontal, and wherein
the guiding arrangement is configured to direct the slurry discharged from the feeding device toward an overflow lip of the flotation tank.
